(19) United States
(12) Patent Application Publication
(10) Pub. No.: US 2004/0056182 A1
(43) Pub. Date: Mar. 25, 2004

(54) Railway obstacle detection system and method

(76) Inventors: James R. Jamieson, Savage, MN (US); Mark D. Ray, Burnsvile, MN (US)

Correspondence Address: CALFEE HALTER & GRISWOLD, LLP, 800 SUPERIOR AVENUE, SUITE 1400, CLEVELAND, OH, 44114, US

(21) Appl. No.: 10/251,422

(22) Filed: Sep. 20, 2002

(51) Int. Cl. H01J 40/14; G06M 7/00

(52) U.S. Cl. 250/221

(57) ABSTRACT

A scanning laser beam railway obstacle detection system disposable on-board a railway vehicle transportable over railway tracks comprises: a laser scanning module optically coupled to a laser source for scanning a laser beam over the tracks ahead of the vehicle with a predetermined pattern; a light detector for receiving light echoes from the scanned laser beam and for converting the light echoes into electrical signals representative thereof; and a processor for processing the electrical signals from the light detector to detect an obstacle ahead of the vehicle. A method of detecting a threat to a railway vehicle transportable over railway tracks comprises the steps of: generating a laser beam; scanning the laser beam over the tracks ahead of the vehicle with a predetermined pattern; receiving light echoes from the scanned laser beam and converting the light echoes into electrical signals representative thereof; determining positions of the light echo signals along the scan pattern; and processing the light echo signals and corresponding positions to produce an image of a scene ahead of the vehicle for use in detecting a threat to the vehicle.

### BACKGROUND OF THE INVENTION

The present invention is directed to railway detection systems, in general, and more particularly, to a scanning laser beam railway obstacle detection system and method.

Early on in the history of the railroad steam engine was the invention of the so-called cow catcher, a device on the front of the train engine car to divert livestock and other obstacles off the track. Today, this device in one form or another is used to clear the track just forward of the wheels to prevent obstacles from entering under the train and causing a derailment. This one safety device was followed by a number of inventions to improve safety, such as the crossing gate, warning lights, fences, and numerous other devices. Despite these safety enhancements, large trains today suffer from a number of transportation accidents often ending in fatalities and harmful environmental effects.

Unfortunately, due to the momentum of the moving train, the size of the vehicle that is struck, and in some cases the configuration of the tracks at the point of collision, significant bodily injury can occur to passengers, including fatalities due to blunt force trauma as well as life threatening lacerations and vehicle entrapment. Moreover, railway systems particularly in the US involve the transportation of industrial chemicals resulting in serious post crash environmental and fire safety hazards that represent significant issues for first responders and citizens near the accident site. These two factors combined can result in significant financial liabilities.

However, the majority of these railway accidents are due to vehicular traffic going around crossing gates, unmarked crossings, crossing gates that fail to alert, or poorly designed crossing configurations. Additionally, railway systems can also be subject to failure or sabotage, resulting in derailment or trains operating on the same track. Yet other obstacles such as intentionally placed devices to derail trains, unsuspecting pedestrians, or livestock can also be in the way of on-coming trains. Therefore, it is of paramount importance to find a way of avoiding train accidents or at least mitigating the effects thereof.

A system having the ability not only to detect railway obstacles forward of the train along the line of sight, but also to detect the integrity of the railway track by examining rail spacing is clearly desirable. Additionally, since the railway track is metallic and of a high reflective nature versus the rail ties and rail gravel bed, a system that can detect, measure, and visualize such track kilometers in advance of the approaching train is also greatly desired. With such systems, visual images of range to obstacles on or close to the track, as well as deviations in track gage and integrity can be determined in sufficient time to take evasive action including speed reductions and stopping the train.

With such systems, it would be possible to detect railway obstructions and potential high rate of closure vehicles and trains that may result in imminent collision. This information can be coupled with GPS positioning and database mapping to identify upstream track features and configurations such as switches, turns, and the likelihood of trains switching to other tracks to avoid a possible collision. This enables safer railway operation, higher rates of speed, and integration with safety control systems to augment man-in-the-loop control.

### SUMMARY OF THE INVENTION

In accordance with one aspect of the present invention, a scanning laser beam railway obstacle detection system disposable on-board a railway vehicle transportable over railway tracks comprises: a laser source for generating a laser beam; a laser scanning module optically coupled to the laser source for scanning the laser beam over the tracks ahead of the vehicle with a predetermined pattern; a light detector for receiving light echoes from the scanned laser beam and for converting the light echoes into electrical signals representative thereof; and a processor for processing the electrical signals from the light detector to detect an obstacle ahead of the vehicle.

In accordance with another aspect of the present invention, a method of detecting a threat to a railway vehicle transportable over railway tracks comprising the steps of: generating a laser beam; scanning the laser beam over the tracks ahead of the vehicle with a predetermined pattern; receiving light echoes from the scanned laser beam and converting the light echoes into electrical signals representative thereof; determining positions of the light echo signals along the scan pattern; and processing the light echo signals and corresponding positions to produce an image of a scene ahead of the vehicle for use in detecting a threat to the vehicle.

### BRIEF DESCRIPTION OF THE DRAWINGS

FIGS. 1A and 1B are plan and elevation view illustrations, respectively, of a railway system suitable for embodying the present invention.

FIG. 2 is a block diagram schematic of a laser control and processing unit 16 suitable for use in the embodiment of FIGS. 1A and 1B.

FIG. 3 is an exemplary illustration of a scan head suitable for embodying a laser beam scanning module for use in the embodiment of FIGS. 1A and 1B.

FIG. 4 is a sketch exemplifying suitable optical elements for use inside the scan head embodiment of FIG. 3.

FIG. 5 is a block diagram schematic of an embodiment for the signal processing of laser beam echoes suitable for use in the system of FIGS. 1A and 1B.

FIGS. 6A and 6B are exemplary illustrations of varying terrain conditions along the railway tracks of the railway system of FIGS. 1A and 1B.

FIG. 7 is an exemplary illustration of the railway vehicle moving in a direction toward a curve in the railway tracks.

FIGS. 8-10 are program flowcharts suitable for use in programming a processor in accordance with an embodiment of the present invention.

FIG. 8A is an exemplary scan scene or field of view (FOV) produced by the embodiment of FIG. 5.

### DETAILED DESCRIPTION OF THE INVENTION

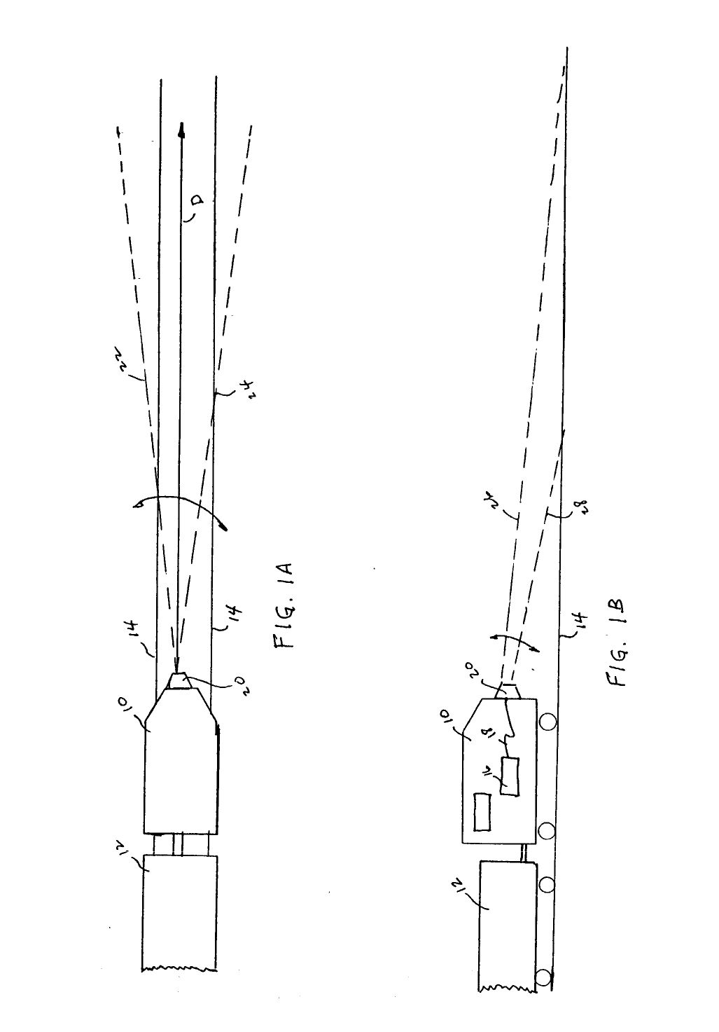

FIGS. 1A and 1B illustrate by plan and elevation views a railway system suitable for embodying the present invention. A railway vehicle, like an engine car 10, for example, may be pulling (or pushing) one or more other cars 12 of a train over railway tracks 14. In the present embodiment, a railway obstacle detection system using the principles of scanning laser obstacle detection is disposed on-board the train, preferably at the front or engine car 10 and comprises a laser control and processing unit 16 linked optically and electrically over lines 18 to a laser scanning module 20, preferably located at the front of the engine car 10. The unit 16 produces a pulsed laser beam over lines 18 to the scanning module 20 which scans the beam over the tracks 14 forward of the train both in azimuth as illustrated by the dashed lines 22 and 24 in FIG. 1A, and in elevation as illustrated by the dashed lines 26 and 28, for example. While a train is used for the present embodiment, it is understood that the present invention may be embodied in other railway vehicles without deviating from the broad principles of the present invention.

In the present embodiment, the scanning module 20 is operative to scan the beam approximately ±5-10° from the center of the tracks 14 and to oscillate the beam approximately ±10° in elevation from a line of sight axis as it is being rotated in azimuth, thus creating a predetermined pattern which for the present embodiment may be sinusoidal. The unit 16 produces laser pulses at a wavelength of 1.5 microns, and at a pulse repetition rate of around 40,000 pulses per second (PPS) with an inter-pulse period of approximately 25 microseconds. Under these conditions, a scene or field of view (FOV) from two meters (2 m) to two kilometers (2 Km) ahead of the train may be created from a processing of laser pulse echoes in the unit 16 as will become better understood from the description found herein below. For the present embodiment, the scene information forward of the train may be updated at a rate of 2 hertz (Hz). It is understood that the settings and conditions used for the present embodiment are merely provided by way of example and other settings and conditions may be used just as well without deviating from the broad principles of the present invention.

The railway obstacle detection system has the ability to not only detect railway obstacles up to 2 km or more under straight line conditions, but also has the ability to detect the integrity of the railway track by examining rail spacing. The scanning module can be tasked to follow the rail and look into turns. Additionally, since the rail-way track is metallic and of a high reflective nature versus the rail ties and rail gravel bed, track can be easily detected, measured, and visualized kilometers in advance of the approaching train. As such, visual images of range to target as well as deviations in track gage and integrity can be sampled in sufficient time to take evasive action including speed reductions and stopping the train automatically.

With this device it is possible to detect railway obstructions and potential high rate of closure vehicles and trains that may result in imminent collision. As will be described in greater detail below, scene information forward of the train obtained by laser scanning can be coupled with GPS positioning and terrain and railway mapping to identify upstream track features and configurations such as switches, turns, and the likelihood of trains switching to other tracks to avoid a possible collision. As such, adapting the fine detail detection, field of view scanning, ranging capability, and merging GPS mapping information permits a high level of automated railway control. This enables safer railway operation, higher rates of speed, and integration with safety control systems to augment man-in-the-loop control and enhance railway/vehicular/pedestrian safety.

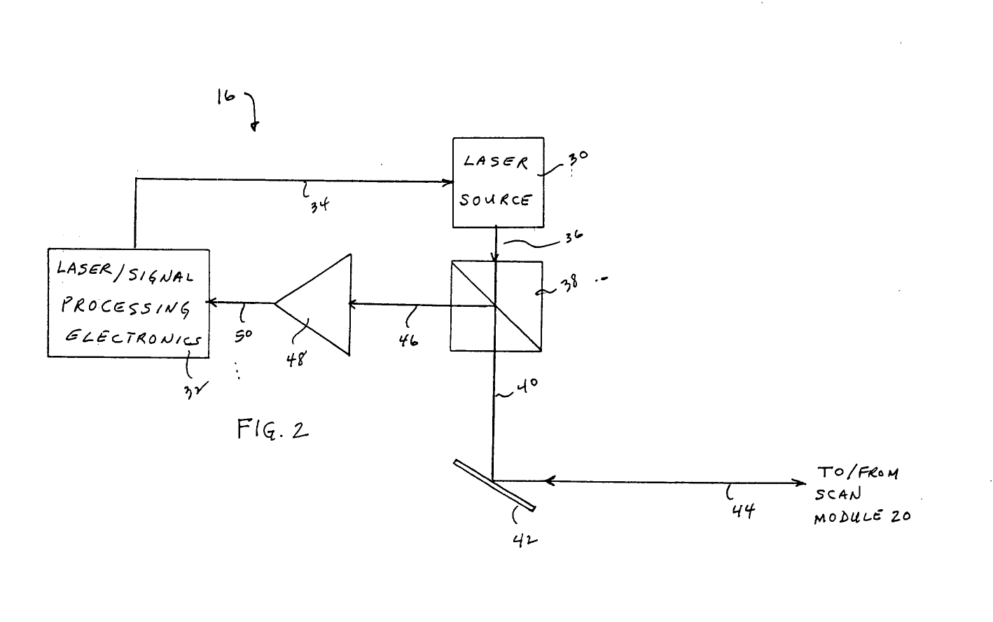

FIG. 2 is a block diagram schematic of a laser control and processing unit 16 suitable for use in the embodiment of FIGS. 1A and 1B. Referring to FIG. 2, a laser source 30 generates laser beam pulses at the pulse repetition rate as controlled by a processing unit 32 via firing signal over line 34, for example. The laser pulses are directed over an optical path 36 to an optical element 38 which may be a polarizing beam splitter, for example. The element 38 passes the laser pulses to an optical path 40. A portion of each generated laser pulse may be reflected to a light detector 48 for indicating a start time thereof. A folding mirror 42 may be disposed in path 40 to direct the laser pulses to the scanning module 20, preferably over a fiber optic cable 44. In the present embodiment, return or echo pulses from obstacles in the path of the pulsed laser beam are received by the scanning module 20 and directed back over the fiber optic cable 44, fold mirror 42 and along path 40 to the optical element 38. However, instead of being passed by element 38, the return echoes are reflected along an optical path 46 to the light detector 48 which may be an avalanche photo-diode or PIN diode, for example. The detector 48 converts the start pulses and light echoes into electrical pulses which are passed on to the processing unit 32 over signal line 50 for further processing as will become more evident from the description to follow. It is understood that the foregoing described embodiment is provided by way of example and that other optical elements and arrangements may be used to generate the laser pulses without deviating from the principles of the present invention.

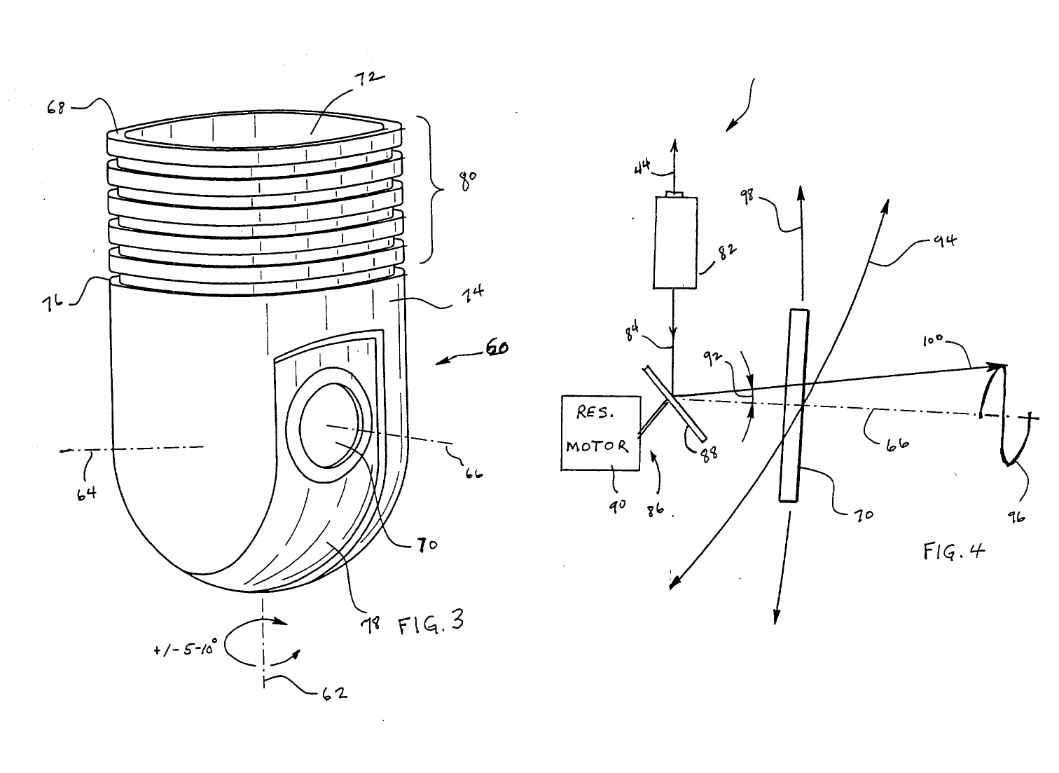

The scanning module 20 may be embodied in a scan head 60 located preferably at the front of the engine car 10 remotely from the optical elements of the unit 16 described above. An exemplary illustration of a suitable scan head 60 is shown in FIG. 3. In this embodiment, the optical elements of the railway obstacle detection system may be disposed within the front or engine car and well supported and protected from the outside environment. The fiber optic cable bundle 44 may be used for the optical path or paths coupling the scan head 60 to the unit 16 as was previously described. The fiber optic cabling 44 may take a circuitous route within the vehicle to reach the scan head 60 which may be mounted to an external surface of the engine car 10 to permit the beam scan patterns to be projected out from the front of the train as described herein above. More than one scan head may be used in the present embodiment without deviating from the principles of the present invention.

Referring to the illustration of FIG. 3, the scan head 60 may control movement of the pulsed laser beam scan patterns along three axes 62, 64 and 66. A top 68 of the scan head 60 may be mounted to a front surface of the engine car 10, for example, such as shown in the illustrations of FIGS. 1A and 1B. A window area 70 of the scan head 60 through which the beam scans are emitted would be pointed in the direction of movement of the engine car 10 along the tracks 14. The fiber optic cable bundle 44 may be passed through a hole in the body of the engine car 10 and into the scan head 60 through an opening 72 at the top 68 thereof. The optical elements within the scan head 60 which will be described in greater detail herein below cause the pulsed laser beam conducted over the path 44 to be scanned vertically up and down about the axis 66. A conventional motor assembly (not shown) within the scan head 60 controls movement of a lower portion 74 thereof in azimuth about the axis 62 with respect to the railway tracks of the train. This movement occurs along a seam 76 between the top and bottom portions, 68 and 74, respectively, and effectively moves the axis 66 along with the lower portion 74 which projects the beam scan pattern through a sinusoidal pattern, for example.

If elevation control of the line of sight axis 66 of laser beam is also desired, another conventional motor (not shown) may be disposed within the scan head 60 to control movement of a portion 78 of the scan head 60 about the axis 64, for example. This movement causes the axis 66 and scan pattern to move in elevation with the portion 78 which includes the window area 70 and falls within the portion 74. In the present embodiment, the window area 70 of the portion 78 may be controlled to move inside the portion 74 to protect it from the environment when not in use. The corrugated skin or surface in the area 80 at the top portion 68 acts as a heat sink to improve the transfer of heat away from the scan head 60 during operation thereof.

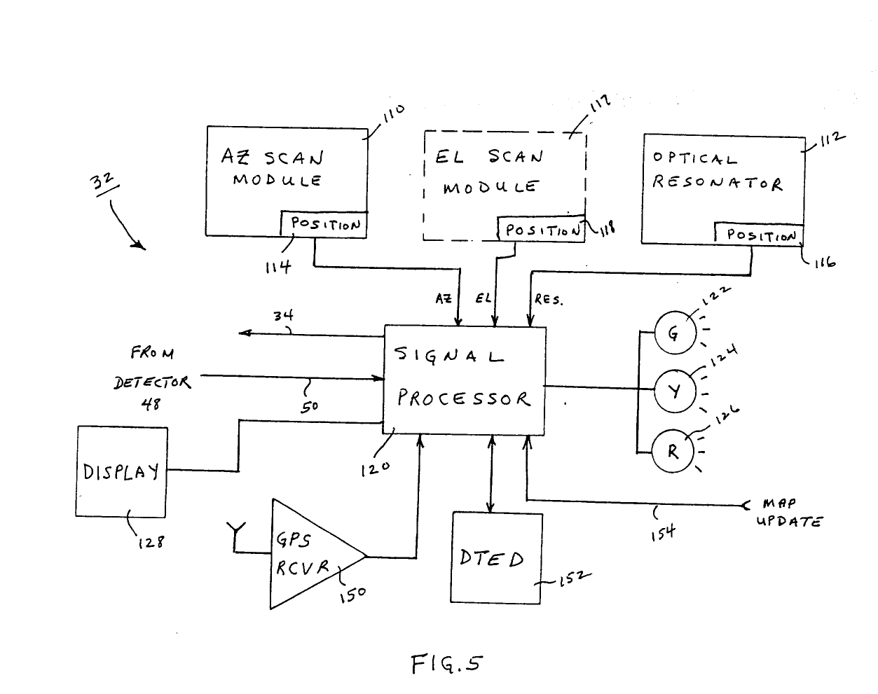

A sketch exemplifying suitable optical elements inside the scan head 60 is shown in FIG. 4. Referring to FIG. 4, the fiber optic cabling 44 providing the optical path for the pulsed laser beam and return echoes is aligned with the axis of the input aperture of a beam expander 82, if used in the present embodiment. The beam exiting the expander 82 may be directed over an optical path 84 to an optical resonator element 86. In the present embodiment, the optical resonator element 86 comprises a vibrating optical mirror element 88 centered and vibrated about the axis 66 by a resonator motor 90 mechanically linked thereto. For a more detailed description of an optical resonator element suitable for use in the present embodiment, reference is made to the pending U.S. patent application Ser. No. 10/056,199, filed Jan. 24, 2002, entitled “Silicon Wafer Based Rotatable Mirror” and assigned to the same assignee as the instant application, which pending application being incorporated by reference herein.

Movement of the mirror element 88 causes the laser beam from the path 84 to be directed vertically up and down across the axis 66 through a maximum predetermined angle 92 which may be on the order of ±10°, for example. The patterned laser beam 100 exits the scan head 60 through the window 70 and is projected along the axis 66. Accordingly, as the axis 66 is moved azimuthally through the path 94, the up and down beam pattern evolves into a sinusoidal pattern 96 as shown in FIG. 4. If desired the axis 66 may also be controlled to move in elevation through a path 98 as described above. It is understood that other optical elements may be used for scanning the laser beam through other patterns, like a rotating optical wedge element or non-mechanical transparent liquid crystal scanner or a microlens array scanner, for example, without deviating from the broad principles of the present invention.

If a rotating optical wedge element is used, for example, the beam conducted over path 84 is aligned with a rotational axis of the element and passed from an input side to an output side thereof. The light beam is refracted in its path through the wedge element and exits perpendicular to an inclined output surface thereof. This refraction of the light beam causes it to exit the scan head 60 as beam 100 through the window area 70 at the angle 92 to the axis 66. Accordingly, as the wedge optical element is rotated 360° about the axis 66, the beam 100 may be projected conically from the scan head 60 to form a helical like scan pattern. The window area 190 may comprise a clear, flat, zero power optical element made of a material like BK7, for example, so as not to interfere substantially with the scan pattern of the exiting beam 100. In this example, the wedge optical element and window 70 are structurally coupled to move together along the azimuth path 94 and elevation path 98 to cause the optical axis 66 to move along therewith. In this manner, the scan pattern 100 is forced to move in azimuth and elevation with the portions 74 and 78 of the scan head 60.

Backscattered light or return echoes will follow the same optical paths as their respectively emitted beam pulses and be returned to the optical elements of unit 16 via the fiber optic bundle 44. While the present embodiment uses a common optical path for both the emitted and return light, it is understood that separate optical paths for emission and return light may be implemented, i.e. a bistatic optical technique, without deviating from the broad principles of the present invention. In such a bistatic system example, one or more fiber optic paths of bundle 44 may be designated for emission light and certain fiber optic paths thereof may be designated for return light. Accordingly, the fiber optic paths of the return light may be coupled directly to the light detector 48 without the use of a beam separator 38, for example.

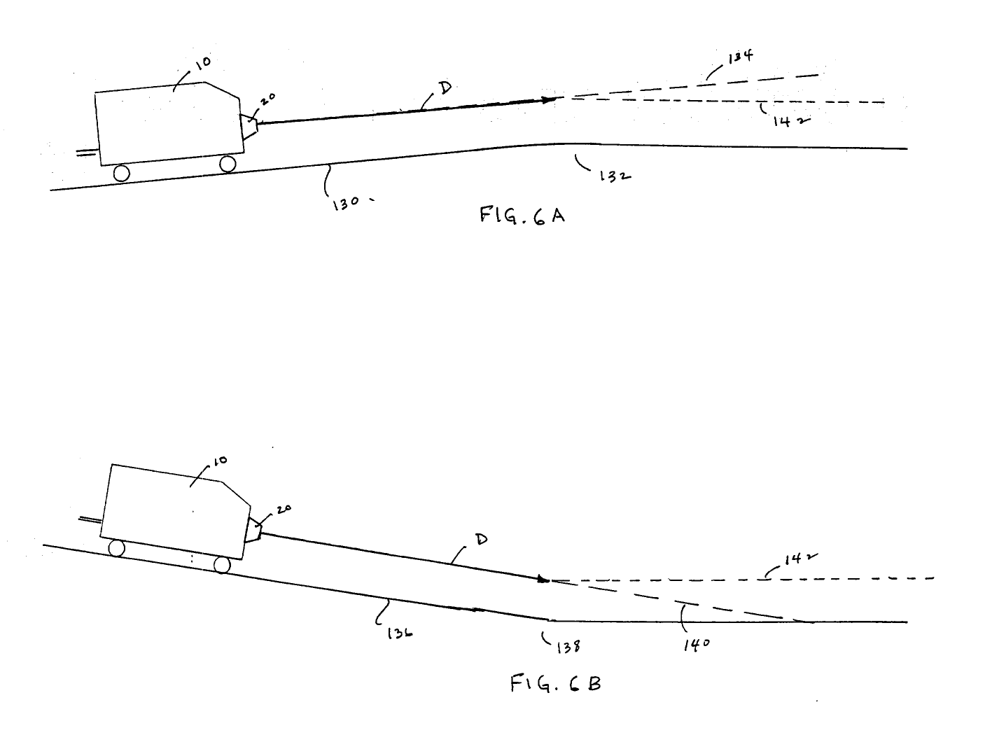

A suitable embodiment for the signal processing portion 32 of unit 16 is shown by the block diagram schematic of FIG. 5. In connection with this embodiment, the azimuth scan module 110 and optical resonator module 112 of the scan head 60 may each include a position sensing unit 114 and 116, respectively. The position sensing unit 112 may sense the azimuth position of the axis 66 and generate an azimuth position signal (AZ) representative thereof which may be coupled to a signal processor 120 of the unit 16 via an appropriate interface. Likewise, the position sensing unit 114 may sense the position of the beam along the projected pattern and generate a beam position signal (RES) representative thereof which may be also coupled to the signal processor 120 via an appropriate interface. In addition, if an elevation control is used in the embodiment which is optional, the elevation scan module 117 of the head 60 may comprise a similar position sensing unit 118 for sensing the elevation position of the axis 66 and generate an elevation position signal (EL) representative thereof which may be also coupled to the processor 120 through an appropriate interface. Accordingly, the processor 120 may record the position of the laser beam at any given time utilizing the signals AZ, EL (if desired), and RES coupled thereto.

Referring to FIG. 5, in the present embodiment, the signal processor 120 receives the electrical signals, representative of the start pulses and return echoes, over line 50 from the light detector 48 and processes such signals to determine the time of arrival (TOA) of the return pulses. Since in the present embodiment, the processor 120 controls the firing of laser pulses, it can ascertain the start of the time of flight of a return signal or alternatively, it can use the start pulses. With this information and the TOA, the processor 120 may compute the time of flight of each of the return signals which is representative of the distance or range from the front of the train to the object causing the reflection. As will become more evident from the more detailed description found herein below, the processor 120 utilizes the range and beam position data of each of the return signals of a complete scan to formulate an electronic scene forward of the train in a scene memory thereof. This scan scene which may represent a full azimuth scan is then used by the processor 120 to determine if any obstacles or threats are in the path of the moving train. The processor 120 is coupled to three lights 122, 124 and 126 which may be colored green, yellow and red, respectively. Based on the results of the threat determination, the processor 120 may light one of these lights to indicate a safe condition or warn the train operator of a perceived impeding collision in sufficient time to avert or minimize the collision. While only three lights are used in the present embodiment, it is understood that more lights or different colored lights may also be used just as well. In addition, a visual display representative of the scene scan forward of the train may be displayed to the train operator through a display monitor 128, if considered desirable. The display monitor 128 may be coupled to the processor 120 through an appropriate display interface.

Since the train does not always travel over flat terrain or in a straight line, another aspect of the present invention compensates for these variations in terrain features or track configurations by dynamically varying a distance vector D (see FIG. 1A) in range for the forward looking laser scan. For flat terrain and straight track conditions, the range vector D may be set at a maximum distance, and a maximum time of flight Tₘₐₓ within the interpulse period of the laser pulse repetition rate may be determined from the vector D and train speed. Accordingly, any return signals received within the interpulse periods outside Tₘₐₓ will not be processed. It is understood that the vector D may be adjusted based of the terrain conditions and/or curves in the track forward of the train.

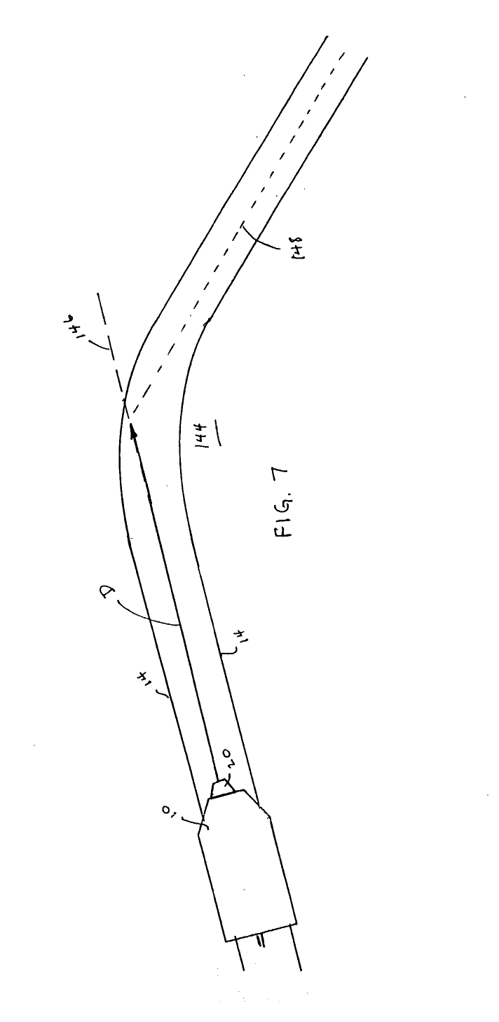

Examples of varying terrain conditions along the railway tracks are shown in the illustrations of FIGS. 6A and 6B. In the illustration of FIG. 6A, the train is traveling up a graded portion of track 130 which will eventually flatten at a juncture 132. Under these conditions, the range vector D will remain parallel to the tracks through the graded portion 130 up to the juncture 132 whereat the tracks become substantially flat. Thus, if range vector D is left unadjusted, return signals to the laser scanner 20 may result from obstacles along the large dashed line 134 which are not along the tracks, but rather in the space above the level of the train. Such return signals may result in a false perception of an impeding collision. In the illustration of FIG. 6B, the train is traveling down a graded portion of track 136 which will eventually flatten at a juncture 138. Under these conditions, the range vector D will remain parallel to the tracks through the graded portion 136 down to the juncture 138 whereat the tracks become substantially flat. Thus, if the range vector D is left unadjusted, return signals to the laser scanner 20 may result from obstacles along the large dashed line 140 which may result in a false perception of an impeding collision of the train with the ground ahead of the train.

In either example, if the range vector D is limited in dimension to only the distance to the terrain change juncture 132 or 138 in each case, no return signals will be processed from obstacles beyond this limited range. Therefore, return signals from obstacles beyond the adjusted range will be ignored reducing the chances of a false perception of train collision. Note that as the train becomes closer and closer to the terrain change junctures, the range vector will be dynamically adjusted smaller and smaller until the train reaches the respective juncture. At the juncture, the range vector will be restored to its maximum dimension along the small dashed line 142 in each case. This will become better understood from the more detailed description heretofollow.

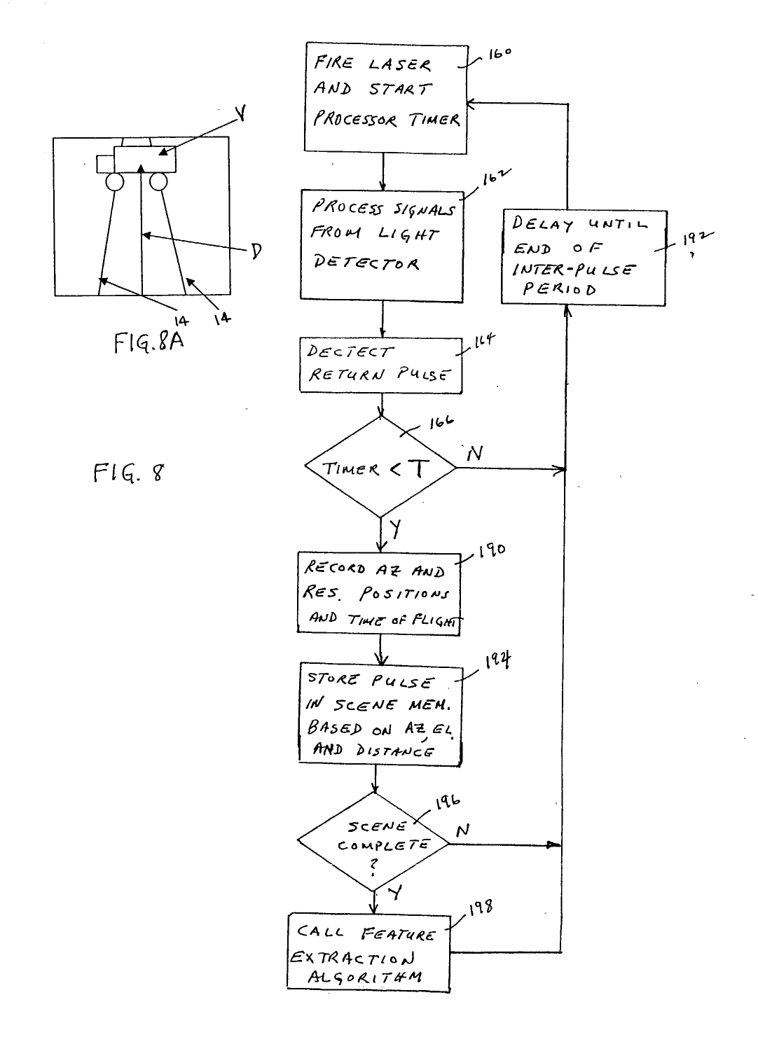

In the illustration of FIG. 7, the train is shown moving in a direction toward a curve in the railway tracks 14 at 144. Thus, if the range vector D is left unadjusted, return signals will result from obstacles along the large dashed line 146 beyond the curve 146 which are no longer along the tracks 14. Once again, if these return signals are processed by the processor 120, a false perception of an impending collision may result. However, if the range vector D is limited to a dimension along the track 14 up to the curve 144, then no return signals resulting from obstacles beyond this distance will be processed and the chances of a false detection of collision will be substantially reduced. Note also that as the train approaches the curve 144, the range vector D will be reduced in dimension until the train comes out of the curve 144, at which time, the range vector D may be restored to its maximum dimension along the small dashed line 148. This will also become better understood from the more detailed description heretofollow.

In connection with adjusting the range vector D, a global positioning satellite (GPS) receiver unit 150 is coupled through an appropriate interface with the signal processor 120 as shown in FIG. 5 to provide the processor 120 with a current position of the train. In addition, a digital terrain elevation map database (DTED) 152 in some form of digital memory is coupled to the processor 120 through an appropriate interface. The DTED may be in the form of a CD-ROM, flash memory card, DVD or the like, for example, and contain map data of the terrain along the railway track route on which the train is moving. In whatever memory form, the DTED map data may include configurations of the track along the route and railway features along the track, such as warning and condition lamps, switches, curves, adjacent tracks, train traffic on the same or adjacent track and the likelihood of trains switching to other tracks to avoid a possible collision, for example. The DTED 152 may be updated by the processor 120 in real time with expected train traffic data from information received from other sources over signal lines 154. Data of terrain, track configuration and features, and expected train traffic ahead of the train may be accessed from the DTED 152 based on the current position of the train obtained from the GPS receiver 150. From this data, the processor 120 may compute the dimension of the range vector D ahead of the train which will become evident from the more detailed description below.

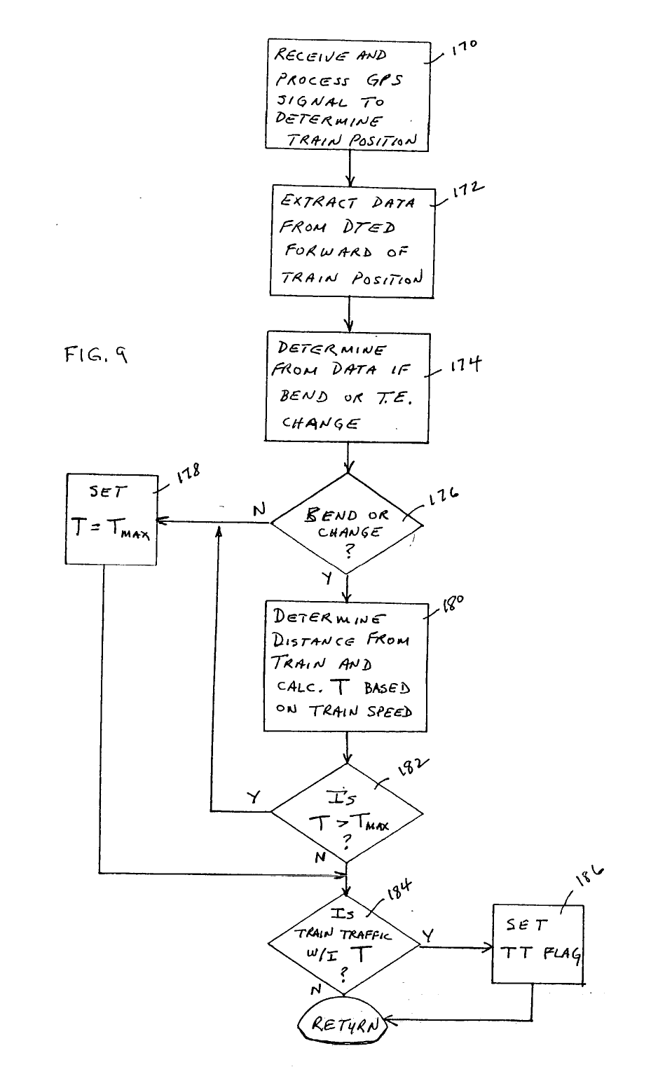

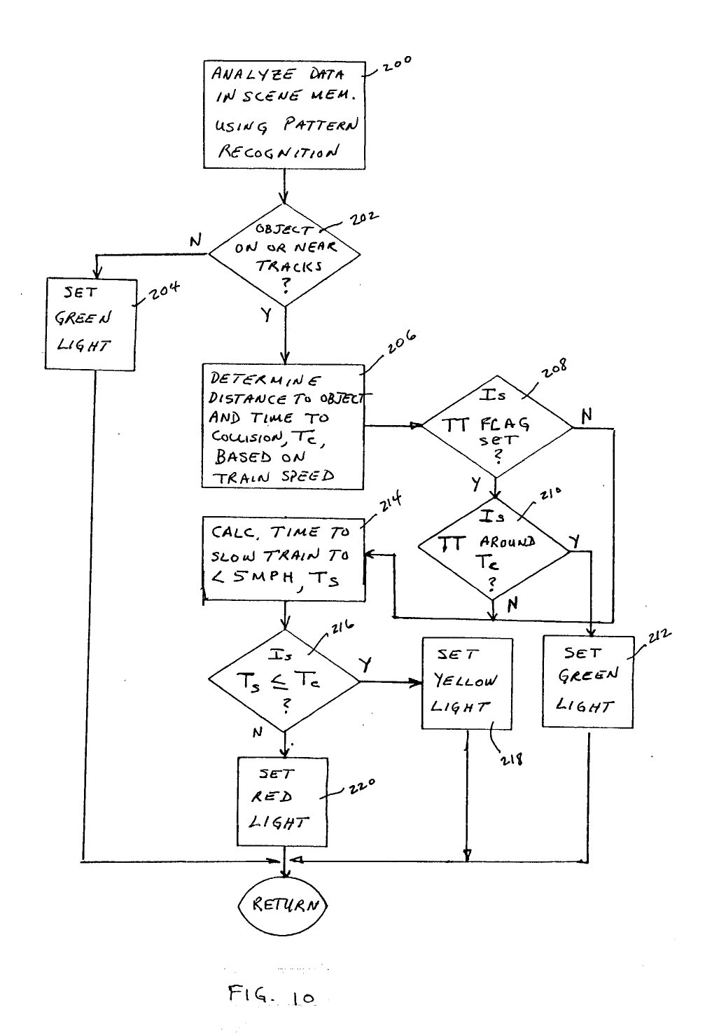

In the present embodiment, the processor 120 may be a microprocessor or microcontroller of the type manufactured by Texas Instruments, bearing model no. TMS320c6711, for example. The processor 120 may be programmed with various algorithms to perform the tasks described herein above. FIGS. 8, 9 and 10 are flowcharts which exemplify these algorithms. Referring to FIG. 8, for example, in block 160, the laser is caused to fire or generate a laser pulse by a signal generated over line 34. Concurrently with the detection of the corresponding start pulse or after a predetermined delay, an internal processor timer is started to count up from preferably a zero count at a predetermined rate based on a desired resolution for determining time of flight of a return signal received within the interpulse period of the corresponding laser pulse. In block 162, the processor processes the return signals received from the light detector within the corresponding interpulse period and in block 164, detects a return pulse which stops the internal timer at a count (TOA) which represents the time of flight or range (distance) of the detected pulse.

Before further processing of the pulse, the processor determines in decisional block 166 if the detected return pulse arrived within the time T which represents the dynamically adjusted range vector D as described herein above. The range vector D may be dynamically set by the algorithm exemplified by the flow chart of FIG. 9 which may be called for execution from time to time or periodically by an executive program of the processor. Referring to FIG. 9, in block 170, a signal from the GPS receiver 150 is received and processed to determine the train position. The speed of the train may be also determined from the GPS signal or from another source which may be a speed sensor located on the train, for example. Then, in block 172 data is extracted or accessed from the DTED 152 forward of the determined train position. Such data would include track configuration, track features, terrain elevation of the ground forward of the train and the most recent update of train traffic. From this accessed data, it is determined in blocks 174 and 176 if there is a bend or curve in the track and/or a terrain elevation change ahead of the train. If no bend or terrain elevation changes exists or in other words, the train is moving along straight and flat track, then the range vector D is set to its maximum dimension Dₘₐₓ and time T is set to the computed time Tₘₐₓ based on Dₘₐₓ and the train speed in block 178.

If a bend or terrain elevation change is detected, then decisional block 176 diverts program flow to block 180 wherein a distance from the train position to the bend or elevation change is determined using the date accessed from the DTED 152. From this distance, the time T is calculated based on the train speed. If the calculated time T is greater than Tₘₐₓ as determined by decisional block 182, then time T is set to Tₘₐₓ in block 178. Otherwise, time T is retained as calculated. In either case, it is next determined in decisional block 184 if there is any expected train traffic within the distance or time T. If so, a train traffic (TT) flag is set in block 186. The program is then returned to the executive of the processor.

Returning to the program of FIG. 8, if the detected pulse arrived within the time T of the interpulse period of the corresponding pulse, then program execution continues at block 190. Else, the detected pulse is not processed and program execution is diverted to block 192 which causes a delay in program execution until the end of the interpulse period and then re-executes block 160. In block 190, the AZ and RES signals are recorded along with the time of flight for the corresponding laser pulse and stored in the scene memory based on the recorded position and range of the corresponding pulse in block 194. In decisional block 196, it is determined if the scan scene is complete. In other words, has the pulsed laser beam scanned through the intended azimuth angle across the track ahead of the train to gather enough data to complete an image of a scan scene in memory. An illustration of such an image scene in memory is shown in FIG. 8A. Referring to FIG. 8A, the exemplary scan scene or field of view (FOV) includes the tracks 14, the range vector D and a vehicle V residing across the tracks ahead of the train. If the scene is complete, a feature extraction algorithm is called for execution in block 198; otherwise, program execution is diverted to blocks 192 and 160 to re-execute the algorithm which will be executed in accordance with the pulse repetition rate of the laser source which may be on the order of 40K pps, for example.

A feature extraction algorithm is exemplified by the flowchart of FIG. 10. Referring to FIG. 10, in block 200, the data of the scene memory is analyzed to determine whether or not an imminent perceived threat is present which is likely to cause a train collision. The analysis may include determining detected return pulses which are all within a common range band or bin and determining a grouping or pattern of such pulses based on position proximity to one another. Using well-known pattern recognition techniques, the shape of the grouping from the scene may be compared with known shapes to determine if the obstacle is a threat to collision, like the vehicle V is FIG. 8A, for example, or a known railway feature. Track integrity ahead of the train may be also determined in this step based on a deviation of the determined pattern from a known track pattern, for example. In decisional block 202, the program determines if an object was extracted from the scene, and if so, is it on or near the tracks and considered a threat to collision or is the condition of the tracks a threat to collision. If no object or no threat is determined in block 202, program execution is diverted to block 204 wherein the green light 122 is turned on. Otherwise, in block 206, the program determines the distance to the object or threat condition, which may be the closest range of the return pulses making up the grouping or pattern of the object or threat as a worst case scenario, for example. From the determined distance, an anticipated time to collision, Tc, may be calculated based on the speed of the train.

Thereafter, in block 208, it is determined whether or not the train traffic (TT) flag is set. If so, as a precaution, it may be next determined, in block 210, if the train traffic is expected at or around the anticipated time of collision Tc. The program may accomplish this determination by accessing the DTED 152 which has the most recent update of train traffic stored therein. Knowing the position of the train from the GPS receiver 150, the program may calculate the distance from the train to the expected train traffic and therefrom compute the time to a passing between trains based on the closing speed of the two trains. Of course, it is presumed that any expected train traffic in proximity to the train would not be on the same tracks, but rather on adjacent tracks. Therefore, if the program determines that the train traffic is expected to pass at or around Tc, then, a safe condition is considered to exist and the green light is lit in block 212.

As a further precaution before setting the green light, the program may also determine whether the shape of the extracted object resembles a cross-section of the front of a train using pattern recognition techniques as described above, and if so, whether the extracted object is on the same tracks or tracks adjacent thereto. This may all be determined from the grouping of pulse returns extracted from the scene as the object in question and from the position of the return pulses thereof. For example, if a majority of the return pulses of the object grouping have azimuth positions within the same tracks, then it is presumed that the object is on the tracks and an unsafe condition exists.

If the TT flag is not set or if train traffic is not expected at or around time Tc or if an unsafe condition is otherwise considered to exist, then a collision threat is perceived and block 214 is executed to calculate a time, Ts, to slow the train or reduce speed to less than a predetermined speed, which may be five miles per hour (5 mph), for example, based on its current speed. Thereafter, in decisional block 216, the program determines if Ts is less than or equal to Tc, i.e. the train is capable of reducing throttle and slowing to less than 5 mph before collision with the object threat. Of course, if the object threat is another train on the same tracks, it is presumed that the other train will have the same or similar railway object detection system and will take the same action. If the decision of block 216 is affirmative, then the yellow light 124 is lit in block 218. Otherwise, the red light 126 is lit by block 220 which indicates to the train operator that emergency action is needed to avoid or mitigate a perceived collision. It is understood that when a light is lit by any of the blocks 204, 212, 218 or 220, it supercedes another light which may be lit. Preferably, only one of the lights 122, 124 or 126 may be lit at any given time.

After a light is lit in the feature extraction algorithm, program execution returns to the processor's executive program until it is called again by the program described in connection with the embodiment of FIG. 8. In the present embodiment, the program exemplified by FIG. 8 may be executed in the processor 120 periodically at forty thousand times a second (40 K/sec) and will produce an image of a scan scene approximately every half second (0.5 sec) or at a rate of two scan scene images a second. Optionally, after a scan scene is complete as identified by decision step 196, the processor may cause the stored scene image to be displayed on the display monitor 128 based on the indices of the stored laser echo signals. The update program described in connection with the embodiment of FIG. 9 may be executed often enough to maintain current measurements of train position and speed data, track features and configurations and train traffic ahead of the train, and to update dynamically the range or distance vector and corresponding time T. It is understood that the program flowchart embodiments described in connection with FIGS. 8-10 are provided by way of example to illustrate tasks being carried out within the processor 120 and that other programs may be used just as well without deviating from the broad principles of the present invention.

While the present invention has been described above in connection with one or more embodiments, it is understood that such embodiments were presented merely by way of example with no intention of limiting the invention in any way, shape or form. Rather, the present invention should be construed in breadth and broad scope in accordance with the recitation of the claims appended hereto.

What is claimed is:

1. A scanning laser beam railway obstacle detection system disposable on-board a railway vehicle transportable over railway tracks comprising:
a laser source for generating a laser beam;
a laser scanning module optically coupled to the laser source for scanning the laser beam over the tracks ahead of the vehicle with a predetermined pattern;
a light detector for receiving light echoes from the scanned laser beam and for converting the light echoes into electrical signals representative thereof; and
a processor for processing the electrical signals from the light detector to detect an obstacle ahead of the vehicle.

2. The system of claim 1 including means for determining the position of the laser beam in the predetermined pattern and for providing a signal representative of the laser beam position to the processor; and wherein the processor is operative to determine a position of the obstacle within the laser scan pattern ahead of the vehicle based on the light echo signals and laser beam position signal associated therewith.

3. The system of claim 2 wherein the laser source is operative to generate laser pulses at a predetermined pulse repetition rate; wherein the processor is operative to determine the start times of the laser pulses and the times of arrival of the light echo signals; and wherein the processor is operative to determine a range to the obstacle ahead of the vehicle based on the laser pulse start times and times of arrival of light echo signals within the corresponding interpulse periods.

4. The system of claim 1 wherein the laser scanning module comprises an optical element for scanning the laser beam vertically across a line of sight; and means for scanning the line of sight azimuthally across the tracks ahead of the vehicle for producing the predetermined pattern of the laser beam.

5. The system of claim 4 wherein the scanning optical element comprises an optical resonator device.

6. The system of claim 5 wherein the optical resonator device comprises an optical mirror element for reflecting the laser beam; and an electrical motor mechanically linked to the optical mirror element for vibrating the optical mirror element through a predetermined vertical angle to produce the laser beam scan pattern.

7. The system of claim 5 wherein the scanning optical element comprises a wedge optical element for refracting the laser beam; and an electrical motor mechanically linked to the wedge optical element for rotating the wedge optical element to produce conical pattern of the laser beam about the line of sight.

8. The system of claim 1 wherein the laser scanning module comprises a scan head having a line of sight for the laser beam and operative to rotate the line of sight through a predetermined azimuth angle across the tracks ahead of the vehicle.

9. The system of claim 1 wherein the laser scanning module is disposable on-board the railway vehicle remote from the laser source and optically coupled thereto over a fiber optic cable.

10. The system of claim 1 wherein the laser scanning module is optically coupled bistatically to the laser source and light detector.

11. The system of claim 1 wherein the railway vehicle comprises a train having at least a front car; and wherein the system is disposable on-board the front car of the train.

12. A scanning laser beam railway threat detection system disposable on-board a railway vehicle transportable over railway tracks comprising:
a laser source for generating a laser beam;
a laser scanning module optically coupled to the laser source for scanning the laser beam over the tracks ahead of the vehicle with a predetermined pattern;
a light detector for receiving light echoes from the scanned laser beam and for converting the light echoes into electrical signals representative thereof;
means for determining positions of the light echo signals along the scan pattern; and
a processor for processing the light echo signals from the light detector and corresponding positions to produce an image of a scene ahead of the vehicle for use in detecting a threat to the vehicle.

13. The system of claim 12 wherein the laser source is operative to generate laser pulses at a predetermined pulse repetition rate; wherein the processor is operative to determine the start times of the laser pulses and the times of arrival of the light echo signals; and wherein the processor is operative to determine ranges of the light echo signals based on the laser pulse start times and times of arrival of light echo signals within the corresponding interpulse periods, which ranges being used by the processor to produce the scene image.

14. The system of claim 13 wherein the scene image is based on the position and range of the light echo signals.

15. The system of claim 14 including a scene memory for storing the light echo signals of the scene image indexed to the positions and ranges thereof.

16. The system of claim 15 wherein the processor is operative to execute a feature extraction algorithm for processing the light echo signal data of the scene memory to determine a threat to the railway vehicle ahead of the train.

17. The system of claim 16 wherein the feature extraction algorithm comprises a pattern recognition algorithm.

18. The system of claim 16 including a means for determining a speed of the railway vehicle; and wherein the processor is operative to determine a time to reach the determined threat based on the speed of the railway vehicle and to provide a threat indication based on the vehicle's ability to reduce speed to a predetermined speed prior to the time to reach the threat.

19. The system of claim 18 including display indicators; and wherein the processor is operative to control the display indicators based on the threat indication.

20. The system of claim 15 including a display monitor coupled to the processor; and wherein the processor is operative to display the light echo signal data of the scene memory on the display monitor.

21. The system of claim 15 including means for determining a current position of the railway vehicle; a data base for storing expected positions of other railway vehicle traffic; and wherein the processor is operative to access the data base based on the current position of the railway vehicle to determine the expected positions of other vehicle traffic in proximity to the railway vehicle and determine a threat to the railway vehicle based on the expected positions of other vehicle traffic.

22. Method of detecting a threat to a railway vehicle transportable over railway tracks comprising the steps of
generating a laser beam;
scanning the laser beam over the tracks ahead of the vehicle with a predetermined pattern;
receiving light echoes from the scanned laser beam and converting the light echoes into electrical signals representative thereof;
determining positions of the light echo signals along the scan pattern; and
processing the light echo signals and corresponding positions to produce an image of a scene ahead of the vehicle for use in detecting a threat to the vehicle.

23. The method of claim 22 including the steps of: generating laser pulses at a predetermined pulse repetition rate; determining the start times of the laser pulses and the times of arrival of the light echo signals; determining ranges of the light echo signals based on the laser pulse start times and times of arrival of light echo signals within the corresponding interpulse periods; and using the determined ranges to produce the scene image.

24. The method of claim 23 including indexing the light echo signals of the scene image to the positions and ranges thereof.

25. The method of claim 24 including executing a feature extraction algorithm for processing the light echo signal data of the scene image to determine a threat to the railway vehicle ahead of the train.

26. The method of claim 25 wherein the step of executing a feature extraction algorithm includes the steps of: grouping the light echo signal data of the scene image into patterns based on the positions and ranges thereof; and recognizing a threat from the patterns.

27. The method of claim 26 including the steps of: determining a speed of the railway vehicle; determining a time to reach the recognized threat based on the speed of the railway vehicle; and providing a threat indication based on the vehicle's ability to reduce speed to a predetermined speed prior to the time to reach the threat.

28. The method of claim 27 including setting display indicators based on the threat indication.

29. The method of claim 24 including displaying the light echo signal data of the scene image on a display monitor based on the indices thereof.

30. The method of claim 24 including the steps of: determining a position of the railway vehicle; determining expected positions of other railway vehicle traffic in proximity to the position of the railway vehicle; and determining a threat to the railway vehicle based on the expected positions of other vehicle traffic.

31. A scanning laser beam railway threat detection system disposable on-board a railway vehicle transportable over railway tracks comprising:
a laser source for generating a laser beam;
a laser scanning module optically coupled to the laser source for scanning the laser beam over the tracks ahead of the vehicle with a predetermined pattern;
a light detector for receiving light echoes from the scanned laser beam and for converting the light echoes into electrical signals representative thereof;
means for determining a current position of the railway vehicle;
a memory for storing a data base of terrain elevation along the track of a route of the railway vehicle; and
a processor coupled to the light detector, position determining means, and data base memory and operative to access the data base memory based on the current position of the railway vehicle to determine terrain elevation of the track forward of the current position of the railway vehicle, to compute a distance vector along the track forward of the vehicle based on the forward track terrain elevation, and to process the light echo signals from the light detector based on the distance vector to detect a threat to the vehicle.

32. Method of detecting a threat to a railway vehicle transportable over railway tracks comprising the steps of:
generating a laser beam;
scanning the laser beam over the tracks ahead of the vehicle with a predetermined pattern;
receiving light echoes from the scanned laser beam and converting the light echoes into electrical signals representative thereof;
determining a current position of the railway vehicle;
determining terrain elevation of the track forward of the current position of the railway vehicle;
computing a distance vector along the track forward of the vehicle based on the determined terrain elevation of the forward track; and
processing the light echo signals based on the distance vector to detect a threat to the vehicle.

33. A scanning laser beam railway threat detection system disposable on-board a railway vehicle transportable over railway tracks comprising:
a laser source for generating a laser beam;
a laser scanning module optically coupled to the laser source for scanning the laser beam over the tracks ahead of the vehicle with a predetermined pattern;
a light detector for receiving light echoes from the scanned laser beam and for converting the light echoes into electrical signals representative thereof,
means for determining a current position of the railway vehicle;
a memory for storing a data base of track configurations of a route of the railway vehicle; and
a processor coupled to the light detector, position determining means, and data base memory and operative to access the data base memory based on the current position of the railway vehicle to determine the track configuration forward of the current position of the railway vehicle, to compute a distance vector along the track forward of the vehicle based on the determined forward track configuration, and to process the light echo signals from the light detector based on the distance vector to detect a threat to the vehicle.

34. Method of detecting a threat to a railway vehicle transportable over railway tracks comprising the steps of:
generating a laser beam;
scanning the laser beam over the tracks ahead of the vehicle with a predetermined pattern;
receiving light echoes from the scanned laser beam and converting the light echoes into electrical signals representative thereof;
determining a current position of the railway vehicle;
determining track configuration forward of the current position of the railway vehicle;
computing a distance vector along the track forward of the vehicle based on the determined forward track configuration; and
processing the light echo signals based on the distance vector to detect a threat to the vehicle.
